(19) United States
(12) Patent Application Publication
(10) Pub. No.: US 2017/0231263 A1
(43) Pub. Date: Aug. 17, 2017

(54) VACUUM ASSISTED NUT CRACKER

(71) Applicant: GROVER A BRITT, JR., RICHFIELD, NC (US)

(72) Inventor: GROVER A BRITT, JR., RICHFIELD, NC (US)

(21) Appl. No.: 15/431,891

(22) Filed: Feb. 14, 2017

Related U.S. Application Data
(60) Provisional application No. 62/295,114, filed on Feb. 14, 2016.

(51) Int. Cl. A23N 5/00

(52) U.S. Cl. CPC A23N 5/00

(57) ABSTRACT

A vacuum-assisted nut cracker having a main chamber with a hard target that cracks nuts is described. A motor driven vacuum pump draws a vacuum through the main chamber and through a suction pipe. The air sucked into the suction pipe draws shelled nuts up the suction pipe. The nuts pick up momentum and fly out the suction pipe onto the hard target, causing the nuts to crack. Shell and cracked nuts drop down and are subsequently collected. Various methods can be used to regulate the air flow, and thus the induced nut momentum. Shelled nuts can be fed into the vacuum-assisted nut cracker either by hand or by locating the nozzle adjacent a pile of nuts.

### CROSS-REFERENCE TO RELATED APPLICATION

This application claims the benefit of priority of U.S. provisional patent application No. 62/295,114, titled “VACUUM ASSISTED NUT CRACKER,” filed on Feb. 14, 2017, which is incorporated herein in its entirety by this reference.

### FIELD OF THE INVENTION

The presently disclosed subject matter is directed to cracking nuts. More particularly, it is directed to a vacuum assisted nut cracker that is suitable for cracking the shells of tens or hundreds of pounds of nuts

### BACKGROUND OF THE INVENTION

Americans enjoy and consume a wide range of nuts including pecans, almonds, filberts, English walnuts, black walnuts, hazelnuts, pistachios, pecans and Brazil nuts. Nuts are consumed individually, as part of a mixed assortment, in pies and in the preparation of numerous other dishes and salads. Nuts are recognized as providing numerous health benefits and include protein, fiber, fats, antioxidants, and a variety of vitamins and minerals. Nuts can also be used to provide a number of cooking oils such as walnut oil and peanut oil. The uses and benefits of nuts are far ranging and varied.

While nuts are deservedly popular there exists the task of separating the nuts from their shells. Some nuts are available pre-shelled, but usually only at higher cost and with at least a perceived reduction in taste and freshness. Some nuts are hand gathered and thus require shelling while other nuts are traditionally left shelled for various holidays. No matter what the reason a user can be faced with the rather daunting task of shelling nuts.

Shelling nuts includes the step of first cracking the shells before removal of the nut meat inside. Cracking can be performed by crushing, cracking roasting prying, slicing or some combination of those approaches. Vises, hammers, gravity drops, nut crackers, screwdrivers, pliers and a large number of other tools or schemes can and have been used. While cracking the shells of a couple of nuts can be done quickly and cheaply using only commonly available hand tools, and while large scale industrial nut cracking can be performed using custom machines, there is no readily available way to easily and economically crack the shells of tens or hundreds of pounds of nuts.

Compounding the problem of easily and economically cracking tens or hundreds of pounds of nuts is that different nuts shells crack differently. Cracking the shell of a walnut is far different from cracking the shell of a Brazil nut. The awkward shapes of some nuts make cracking their shells either easier or harder than other nuts. For example, the “football shape” of almonds means they must be handled differently than the rather round shape of walnuts.

In view of the foregoing a machine that can economically and effectively crack the shells of tens or hundreds of pounds would be beneficial. Even more beneficial would be a machine that can economically and effectively crack the shells of different nuts. Preferably such a machine would be usable with a mixed assortment of nuts.

### BRIEF SUMMARY OF THE INVENTION

The principles of the present invention provide for an improved nut shell cracker for cracking the shells of nuts. A nut cracker in accord with the present invention can economically and effectively crack the shells of tens or hundreds of pounds of nuts. Such a nut cracker can be used with different nuts and with mixed assortments of nuts.

A nut cracker that is in accord with the present invention includes a main chamber having an inlet port, an exhaust port, and an internal hard target. Also included is a vacuum pump for drawing an air flow through the inlet port, into the main chamber and out the exhaust port. Also included is a hard target located inside the main chamber and in the path of the air flow. The air flow is sufficient to cause a nut passing the inlet port to gain sufficient momentum to strike the hard target so as to crack.

In practice the hard target can be steel. In addition, a suction pipe may be operatively connected to the inlet nozzle for directing air flow into a suction pipe input. There may also be an inlet nozzle coupling the suction pipe to the inlet port. The vacuum pump is beneficially located in the main chamber. If so, a filter may be operatively connected to the vacuum pump. The vacuum pump is preferably motor driven and the air flow may pass through the filter before it enters the vacuum pump. Preferably, the air flow passes out of the vacuum pump and out the exhaust port. Thus, the air flow may be drawn into the inlet port, through the main chamber, through the filter and out the exhaust port. In practice the exhaust port is an opening in the main chamber.

An air shield may be disposed between the inlet port and the exhaust port. That air shield is for regulating the air flow. If so, a suction pipe may be operatively connected to the inlet nozzle for directing air flow into a suction pipe input. Then, an inlet nozzle may be used to couple the suction pipe to the inlet port. In practice the vacuum pump is located within the main chamber and a filter is operatively connected to the vacuum pump.

Alternatively air flow can be controlled by the vacuum pump motor or by the suction pipe input. In any even air flow can cause nuts to be drawn into the suction pipe with sufficient momentum that they strike the hard target.

### BRIEF DESCRIPTION OF THE DRAWINGS

The advantages and features of the present invention will become better understood with reference to the following detailed description and claims when taken in conjunction with the accompanying drawings, in which like elements are identified with like symbols, and in which:

FIG. 1 is an isometric view of a vacuum-assisted nut cracker 10 that is in accord with the principles of the present invention.

FIG. 2 is a side view of the vacuum-assisted nut cracker 10 shown in FIG. 1;

FIG. 3. is an isolation view showing the inlet nozzle 35 of the vacuum-assisted nut cracker 10 shown in FIG. 1;

FIG. 4 is a cut-away view of the operating input configuration of the vacuum-assisted nut cracker 10 shown in FIG. 1; and

FIG. 5 is a block diagram illustrating the internal air flow of the vacuum-assisted nut cracker 10 shown in FIG. 1.

DESCRIPTIVE INDEX

10 vacuum-assisted nut cracker

15 main chamber

17 internal hard target

20 inlet port

25 exhaust port

45 vacuum pump

50 air flow

53 suction pipe input

60 air shield

100 nuts

### DETAILED DESCRIPTION OF THE INVENTION

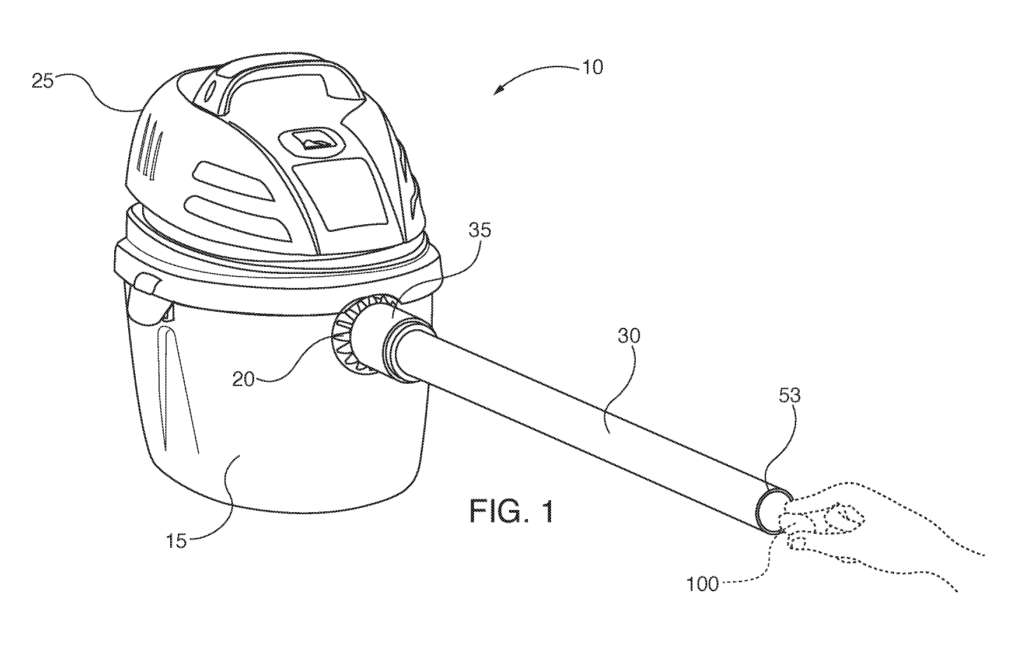

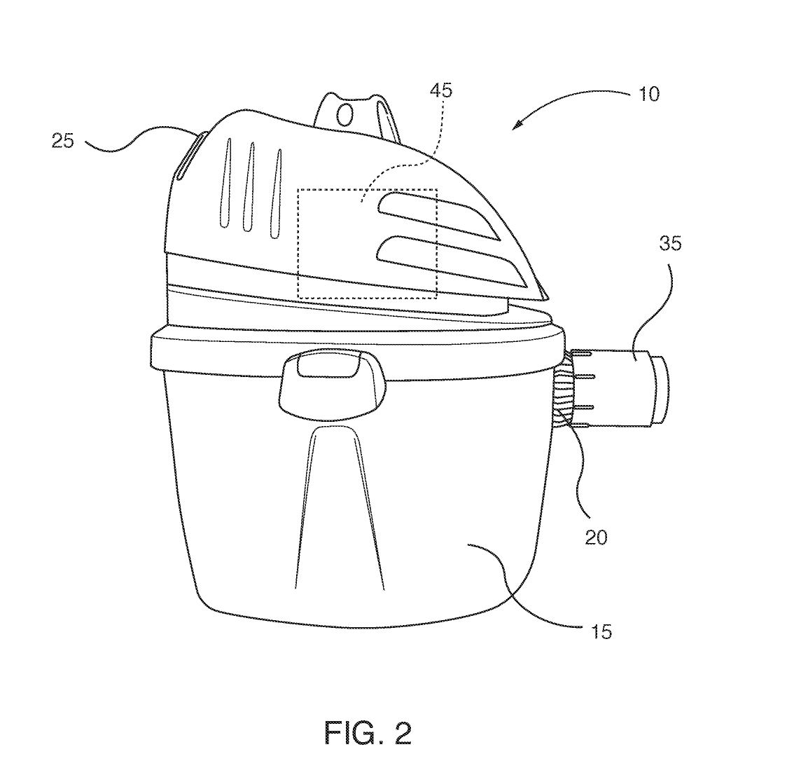

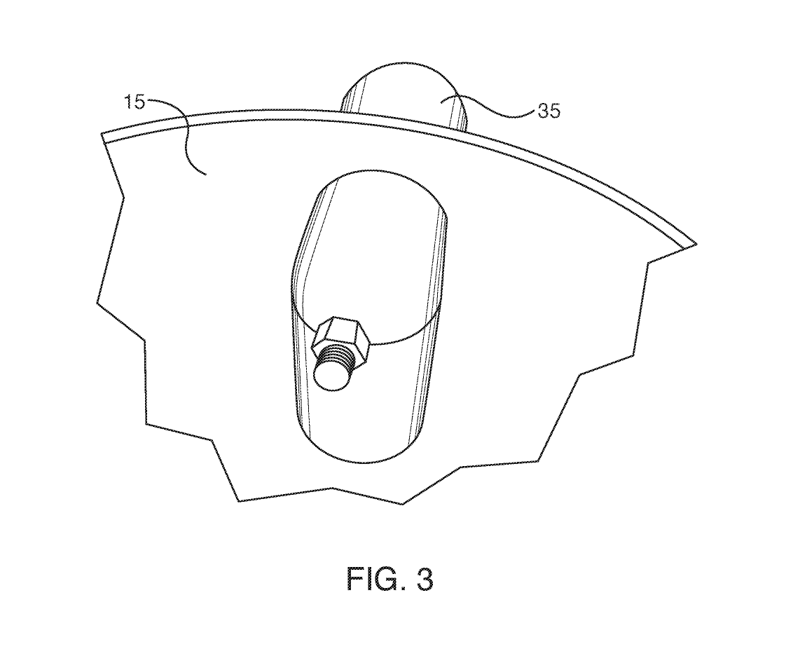

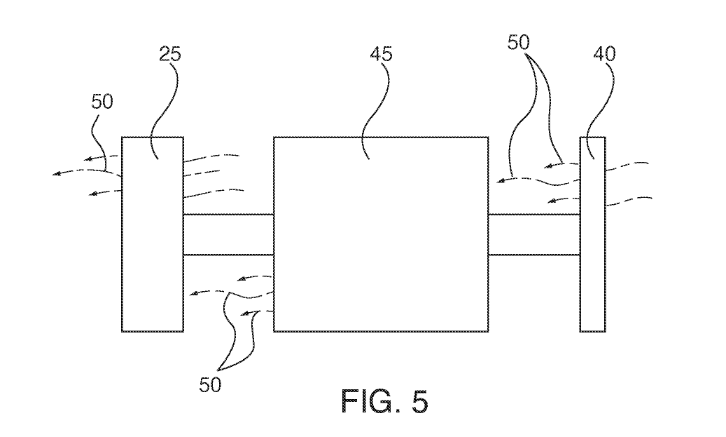

The preferred embodiment of the present invention is illustrated in FIGS. 1 through 5. However, the invention is not limited to the specifically described embodiment. A person skilled in the art will appreciate that many other embodiments of the invention are possible without deviating from the basic concept of the invention. Any such work around will also fall under the scope of this invention.

The terms “a” and “an” as used herein do not denote a limitation of quantity, but rather denote the presence of at least one of the referenced items.

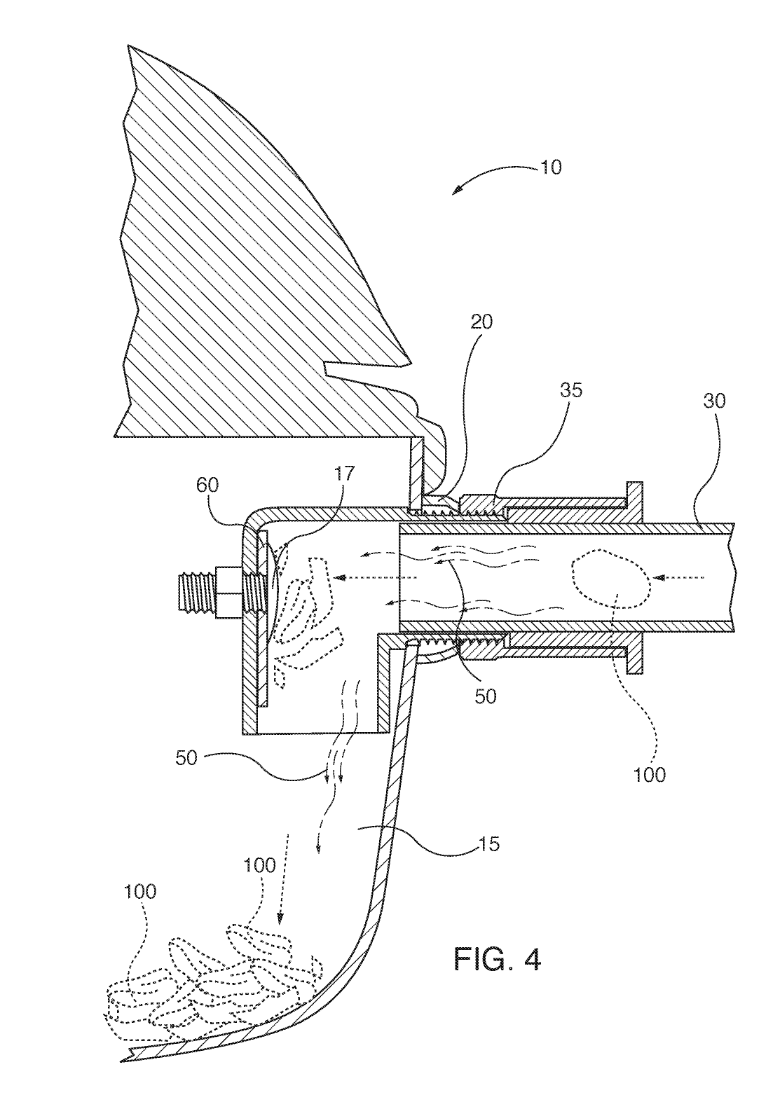

The present invention describes a vacuum-assisted nut cracker 10 that is suitable for cracking the shells of relatively large volumes of nuts 100 quickly, effectively, easily, and economically. Referring now to FIGS. 1 and 4, the vacuum-assisted nut cracker 10 includes a main chamber 15 having an internal hard target 17 (FIG. 4) which is preferably made of steel.

The main chamber 15 also includes an inlet port 20 to which an inlet nozzle 35 is attached and an exhaust port 25. The inlet port 20 receives the inlet nozzle 35 which couples to a suction pipe 30 having a suction pipe input 53. Turning now to FIGS. 1, 4, and 5 the exhaust port 25 is the output of a motor operated vacuum pump 45. The motor operated vacuum pump 45 draws an air flow 50 into the suction pipe input 53, through the suction pipe 30, through the inlet nozzle 35, past the inlet port 20, into and through the main chamber 15, through a filter 40 and out the exhaust port 25.

In practice the vacuum pump 45 and filter 40 can be and preferably are contained within the main chamber 15, while the exhaust port port 25 is an opening in the main chamber 15. Turning now to FIG. 4, the vacuum-assisted nut cracker 10 beneficially includes an air shield 60 that is located somewhat adjacent to the inlet port 20. In practice and as shown the air shield 60 then can be used to hold the hard target 17. The air shield 60 regulates the air flow 50 that is drawn into the main chamber 15. Alternative methods of regulating the air flow 50 include controlling the speed of the vacuum pump 45 motor, controlling the air flow 50 into or out of the filter 40, controlling the air flow 50 out of the exhaust port 25, adjusting the air flow 50 as it passes the inlet port 20 or flows through the suction pipe 30. For example, the airflow 50 can be adjusted by using a different-sized suction pipe input 53.

In use the vacuum pump 45 is turned on and the air flow 50 through the vacuum-assisted nut cracker 10 is regulated as is described in more detail subsequently. The suction pipe input 53 is then fed with nuts 100 either by hand or by locating the suction pipe input 53 adjacent a pile of nuts 100 to draw them into the suction pipe 30.

Referring now primarily to FIG. 4, the air flow 50 causes the nuts 100 to be drawn into the suction pipe 30. The nuts 100 pick up momentum from the air flow 50 and fly past the inlet port 20 onto the hard target 17. Thus the hard target 17 must be located such that the nuts 100 that fly past the inlet port 20 hit the hard target 17. The proper air flow 50 is that which induces sufficient momentum such that when a nut 100 impacts the hard target 17 the nut 100 cracks and both the nut meat itself and the shell fall toward the bottom of the main chamber 15. In practice, with the proper air flow a high percentage of the nuts drawn into the suction pipe 30 can be cracked. In fact routinely over 90% of the nuts drawn into the suction pipe 30 are cracked.

The hard target 17 is configured to block the shells and cracked nuts from flying to the filter 40. The dimensions of the main chamber 15 are such that while the suction pipe 30 has a high air flow area per square inch (or square cm) the main chamber 15 has a much smaller air flow per unit area. Thus the nut meat and shells tend to drop almost straight down after hitting the hard target 17. Therefore the distance between the input port 20 and the hard target 17/air shield 60 can be important. Therefore some experimentation may be required.

The foregoing descriptions of a specific embodiment of the present invention have been presented for purposes of illustration and description. They are not intended to be exhaustive or to limit the invention to the precise forms disclosed. Many modifications and variations are possible in light of the above teaching. The specific embodiment was chosen and described in order to best explain the principles of the invention and its practical application. This will enable others skilled in the art to best utilize the invention and various embodiments with various modifications as are suited to the particular use contemplated.

What is claimed:

1. A nut cracker, comprising:
a main chamber having an inlet port, an exhaust port, and an internal hard target;
a vacuum pump drawing an air flow through said inlet port, into said main chamber and out said exhaust port;
a hard target inside said main chamber and in the path of said air flow;
wherein said air flow is sufficient to cause a nut passing said inlet port to gain sufficient momentum to strike said hard target.

2. The nut cracker according to claim 1, wherein said hard target is comprised of steel.

3. The nut cracker according to claim 1, further comprising a suction pipe operatively connected to said inlet nozzle for directing air flow into a suction pipe input.

4. The nut cracker according to claim 3, further including an inlet nozzle coupling said suction pipe to said inlet port.

5. The nut cracker according to claim 1, wherein said vacuum pump is located in said main chamber.

6. The nut cracker according to claim 1, further comprising a filter operatively connected to said vacuum pump.

7. The nut cracker according to claim 6, wherein said vacuum pump is motor driven.

8. The nut cracker according to claim 7 wherein said air flow passes through said filter before it enters said vacuum pump.

9. The nut cracker according to claim 8, wherein air flow passes from said vacuum pump and out said exhaust port.

10. The nut cracker according to claim 9, wherein said air flow is drawn into said inlet port, through said main chamber, through said filter and out said exhaust port.

11. The nut cracker according to claim 10, wherein said exhaust port is an opening in said main chamber.

12. The nut cracker according to claim 1, further including an air shield disposed between said inlet port and said exhaust port, said air shield for regulating said air flow.

13. The nut cracker according to claim 12, further comprising a suction pipe operatively connected to said inlet nozzle for directing air flow into a suction pipe input.

14. The nut cracker according to claim 13, further including an inlet nozzle coupling said suction pipe to said inlet port.

15. The nut cracker according to claim 14, wherein said vacuum pump is located within said main chamber.

16. The nut cracker according to claim 15, further comprising a filter operatively connected to said vacuum pump.

17. The nut cracker according to claim 7, wherein said air flow is controlled by said vacuum pump motor.

18. The nut cracker according to claim 3, wherein said suction pipe input controls said air flow.

19. The nut cracker according to claim 3, wherein said air flow causes nuts to be drawn into said suction pipe.

20. The nut cracker according to claim 15 wherein said nuts pick up sufficient momentum from said air flow to strike said hard target.
